(19) United States
(12) Patent Application Publication
(10) Pub. No.: US 2013/0132106 A1
(43) Pub. Date: May 23, 2013

(54) Medical Product Request and Replacement Information System

(71) Applicant: Thomas A. Perry, Basking Ridge, NJ (US)

(72) Inventor: Thomas A. Perry, Basking Ridge, NJ (US)

(73) Assignee: Pharmatek Systems, LLC, Montvale, NJ (US)

(21) Appl. No.: 13/299,244

(22) Filed: Nov. 17, 2011

(51) Int. Cl. G06Q 50/22

(52) U.S. Cl. 705/2

(57) ABSTRACT

A computer-implemented method including receiving, from a health care provider client device, an electronic trigger signal, the trigger signal indicating a change in health care information stored in one or more electronic databases associated with the health care provider, obtaining, from the one or more electronic databases and in response to receiving the trigger signal, health care provider information, filtering, using one or more computer-processors, the health care provider information to identify a patient eligible for participation in a patient assistant program, generating a health care product request application for a patient identified as eligible for participation in the patient assistant program, and outputting the health care product request application.

### BACKGROUND

Health care providers, such as hospitals and related hospital systems, are required to treat patients regardless of their ability to pay for services rendered. To assist the health care providers, health care product manufacturers (e.g., pharmaceutical companies and medical device companies) and/or charitable organizations may offer safety net and patient assistance programs where health care products, such as drugs, stents, or pacemakers, are made available to health care providers at a reduced cost or for free on condition that the health care providers can demonstrate the patient or patients receiving the health care product(s) meet specified eligibility requirements. Such patient assistance programs are available in a wide array of health care areas including, for example, cardiology, hematology, rheumatology, neurology, wound care, gastroenterology, nephrology, oncology and behavioral health. To be eligible to participate in a patient assistance program, and thus receive the free or reduced cost health care products, patients and/or health care providers are generally required to submit specific documentation and patient information to the charitable organization or manufacturer for approval.

The eligibility requirements can vary across different manufacturers/charitable organizations. Examples of information required to demonstrate eligibility include one or more physician signatures, a patient or guardian's signature, proof of income or lack thereof (e.g., W-2, pay stub, income letter, charity care approval letter), demographic information, and/or insurance information. In some cases, the provider is required to supply the eligibility information in an application specific to the product, manufacturer, and/or charitable organization. Moreover, the health care provider may be required to track shipment of the product and submit proof, in the form of drug administration records or flow sheets, that the product was received and used as prescribed.

### SUMMARY

The subject matter of this disclosure relates to requesting free or reduced medical products and systems for performing the same.

In general, certain aspects of the disclosure feature a computer-implemented methods that include receiving, from a health care provider client device, an electronic trigger signal, the trigger signal indicating a change in health care information stored in one or more electronic databases associated with the health care provider, obtaining, from the one or more electronic databases and in response to receiving the trigger signal, health care provider information, filtering, using one or more computer-processors, the health care provider information to identify a patient eligible for participation in a patient assistant program, generating a health care product request application for a patient identified as eligible for participation in the patient assistant program, and outputting the health care product request application

Implementations of the methods can include one or more of the following features. For example, filtering can include identifying, from the health care provider information, a health care product being offered in the patient assistance program. The filtering further can include identifying a patient associated with the health care product being offered in the patient assistance program. The filtering further can include comparing patient information associated with the patient against the eligibility requirements of the patient assistance program and identifying the patient as an eligible patient when the patient information meets the eligibility requirements. Generating the health care product request application can include populating the health care product request application with at least some of the patient information. The patient treatment information can include patient medication information, a treatment schedule for the patient, and/or patient accounting information.

In some implementations, outputting the health care product request application includes submitting the treatment product application to a health care product supplier.

In some implementations, the health care product request application includes a request for reimbursement of the cost of a health care product.

In some implementations, the health care product request application includes a request for a health care product. The health care product request application can be a request for a refill of the health care product.

Certain aspects of the disclosure also feature systems that include one or more computing devices configured to perform operations including: receiving, from a health care provider client device, an electronic trigger signal, the trigger signal indicating a change in health care information stored in one or more electronic databases associated with the health care provider, obtaining, from the one or more electronic databases and in response to receiving the trigger signal, health care provider information, filtering, using one or more computer-processors, the health care provider information to identify a patient eligible for participation in a patient assistant program, generating a health care product request application for a patient identified as eligible for participation in the patient assistant program, outputting the health care product request application.

Implementations of the systems can include one or more of the following features. For example, filtering can include identifying, from the health care provider information, a health care product being offered in the patient assistance program. Filtering further can include identifying a patient associated with the health care product being offered in the patient assistance program. Filtering further can include comparing patient information associated with the patient against the eligibility requirements of the patient assistance program and identifying the patient as an eligible patient when the patient information meets the eligibility requirements.

In some implementations, generating the health care product request application includes populating the health care product request application with at least some of the patient information. The patient treatment information can include patient medication information, a treatment schedule for the patient, and or patient accounting information.

In some implementations, outputting the health care product request application includes submitting the treatment product application to a health care product supplier. The health care product request application can include a request for reimbursement of the cost of a health care product, a request for a health care product, and/or a request for a refill of the health care product.

In certain aspects, the disclosure features a storage medium having instructions stored thereon that, when executed by data processing apparatus, cause the data processing apparatus to perform operations including receiving, from a health care provider client device, an electronic trigger signal, the trigger signal indicating a change in health care information stored in one or more electronic databases associated with the health care provider, obtaining, from the one or more electronic databases and in response to receiving the trigger signal, health care provider information, filtering, using one or more computer-processors, the health care provider information to identify a patient eligible for participation in a patient assistant program, generating a health care product request application for a patient identified as eligible for participation in the patient assistant program, and outputting the health care product request application.

Implementations of the storage medium having the instructions stored thereon can include one or more of the following features. For example, in some implementations, filtering includes identifying, from the health care provider information, a health care product being offered in the patient assistance program. The filtering further can include identifying a patient associated with the health care product being offered in the patient assistance program. The filtering further can include comparing patient information associated with the patient against the eligibility requirements of the patient assistance program and identifying the patient as an eligible patient when the patient information meets the eligibility requirements. Generating the health care product request application can include populating the health care product request application with at least some of the patient information. The patient treatment information can include patient medication information, a treatment schedule for the patient, and/or patient accounting information.

In some implementations, outputting the health care product request application includes submitting the treatment product application to a health care product supplier.

In some implementations, the health care product request application includes a request for reimbursement of the cost of a health care product.

In some implementations, the health care product request application includes a request for a health care product.

In some implementations, the health care product request application is a request for a refill of the health care product.

Through the automatic collection and organization of information from a variety of sources, as well as document generation and population based on the organized information, various implementations of the patient health care product system and process of the present disclosure can be used to substantially reduce the labor, time and cost associated with both preparing requests to participate in patient assistance programs and following up through the application process.

The details of one or more embodiments are set forth in the accompanying drawings and the description below. Other features and advantages will be apparent from the description, the drawings, and from the claims.

### DESCRIPTION OF DRAWINGS

FIG. 1 is a schematic illustrating an example of a patient health care product request system.

FIG. 2A is a schematic that illustrates an example of a connection between a health care provider and a health care product request system and between the health care product requests system and a health care product supplier.

FIG. 2B is a schematic illustrating an example of data flow between a health care provider and a health care product request system and between the health care product requests system and a health care product supplier.

FIG. 3 is a flow chart of an example process for participating in a patient assistant program.

FIG. 4A is an example image of a document generated by a patient assistance request engine.

FIG. 4B is an example image of a portion of the document of FIG. 4A.

FIG. 4C is an example image of a portion of the document of FIG. 4A.

FIG. 4D is an example image of a portion of the document of FIG. 4A.

FIG. 4E is an example image of a signature provided by a physician for a request form.

FIGS. 5-12 are example screenshots of management reports for presentation to a user.

### DETAILED DESCRIPTION

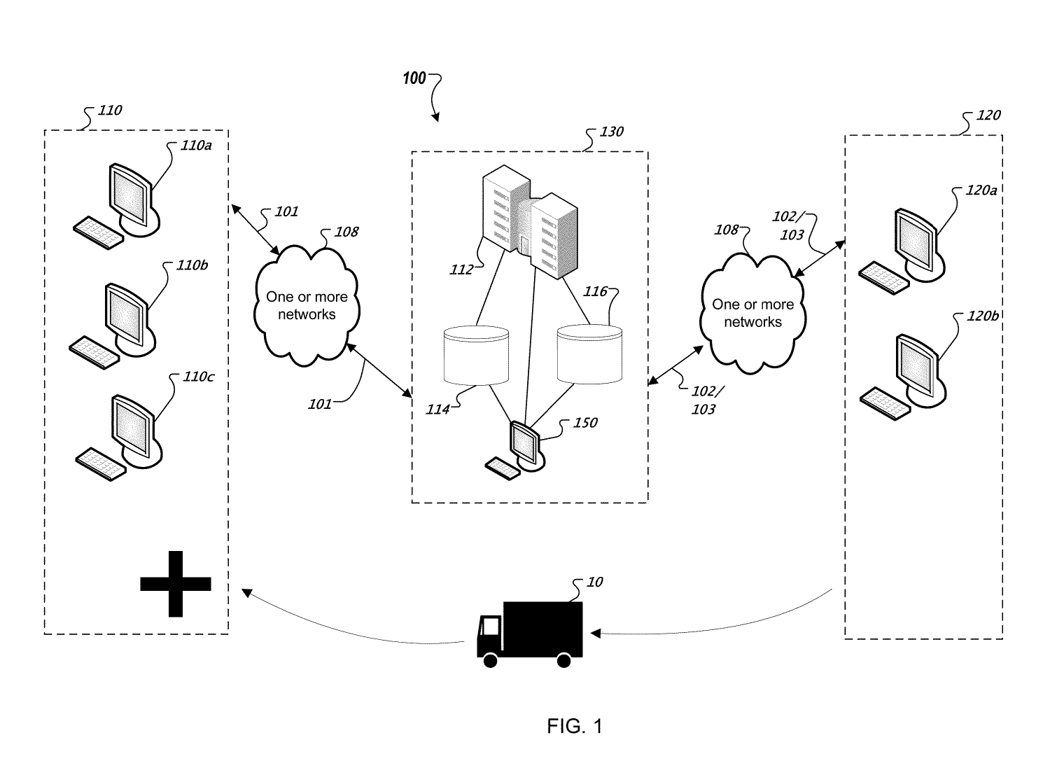

FIG. 1 is a schematic that illustrates an example of a patient health care product request system 100 that, among other things, collects and organizes health care information about patients and health care products, submits requests to participate in patient assistance programs, tracks health care product delivery. For the purposes of this disclosure, a patient assistance program includes offers/proposed agreements established by a health care product manufacturer/supplier to either help a hospital recover health care product(s) given to eligible patients or assist an eligible patient obtain health care product(s) at a discount or free of charge.

In some embodiments, the system 100 collects and organizes information about a patient and/or about health care product(s) requested for the patient from a health care provider 110. The system 100 compiles the information into a health care product supplier specific document that requests the product itself or reimbursement for the product's cost. The system 100 submits the document to the health care product supplier 120 for approval or denial of the request. Upon approving a request, the health care product supplier 120 can send a shipment 10 (e.g., using any suitable shipping method) containing the requested health care product to the health care provider, where the shipment can be tracked by system 100. Alternatively, if the health care provider already has the product, the supplier can debit the health care provider's account for the cost of the product. The system 100 is also operable to automate refill requests to the supplier, send various notifications to the individuals including the health care provider, patient and product supplier, and offer to the health care provider an analysis of savings obtained through participation in patient assistance programs.

The system 100 can communicate with health care provider(s) client devices (110a, 110b, 110c) through one or more communication networks 108 (e.g., internet, intranet, mobile phone network) to obtain information 101 relevant to submitting a health care product request to a health care product supplier 120, such as a manufacturer or charitable foundation. Relevant information can include information such as patient information, health care product information, and/or eligibility information. A health care provider 110 includes an entity capable of providing health care services, such as a hospital or doctor's office, to one or more patients and may include individuals (e.g., doctor, nurse practitioner, nurse, health care provider administrator, or patient advocate), collection of individuals, or organization(s) that work for or on behalf of the health care providing entity.

The system 100 also can communicate with one or more health care product supplier client devices (120a, 120b) through the one or more communication networks 108 to submit a request 102 for health care products at reduced or no cost. A health care product supplier can include health care product manufacturers or charitable organizations that are capable of shipping a health care product upon approval of a request to participate in a patient assistance program. The health care product supplier does not, however, necessarily have to provide a health care product. Instead, in some implementations, the health care product supplier can provide a reimbursement for health care products that will be or have been used by the health care provider.

Health care product requests 102 can be generated based on the information obtained from the health care provider. The health care product supplier 120 processes requests 102 received at supplier client device(s) (120a or 120b) to accept or deny requests for health care products. Once an order is placed and a health care product shipped from the health care product supplier 120, the system 100 can communicate with the client device(s) (120a, 120b) to track delivery of health care products and to request replacement health care products for patients. For example, the system 100 can submit requests for refills of health care products and/or changes in the health care product quantity. In addition, the system 100 can update the health care provider accounting information when an application for a patient assistant program has been accepted and/or the health care provider is reimbursed. The system 100 also can communicate with one or more health care product supplier client devices (120a, 120b) through the one or more communication networks 108 to obtain information 103 regarding patient assistance programs. For example, the information 103 can include the type or category of information required by the health care product supplier 120 to make a decision on whether to supply the health care product or reimburse the cost of the health care product (e.g., patient eligibility requirements).

A client device can include, for example, a computing device such as a personal computer, laptop computer, mobile phone, smart phone or electronic touch pad device. In some implementations, the client devices can include or are electronically coupled to one or more databases that store information to be provided in a health care product request. For example, the databases can store patient medical information (e.g., information relating to the patient's medical history or a medical procedure to be performed on the patient), patient accounting information (e.g., patient employment history, history of patient payments for services rendered), patient insurance information, patient demographic information, patient scheduling information, and health care product information, among other information. The foregoing information can be saved in a single database or in multiple different databases stored on one or more servers of the health care provider. In some implementations, the information is stored on databases of entities associated with but separate from the health care provider (e.g., pharmacies).

The health care product request system 100 can include one or more product request application servers 112, such as servers deployed in a data center 130 or in different geographic locations. The application servers 112 execute and/or store computer programs that can implement, among other things, web applications and/or health care product request applications for receiving, obtaining, modifying, and filtering data (e.g., patient data, health care product data, and health care product replacement program data) and generating, outputting and/or tracking health care product request applications. A computer program can execute on a single application server 112 or, alternatively, the program can be organized into components that execute on multiple application servers 112. There can be more than one instance or copy of a given computer program executing on the collection of application servers 112 at any given time. In some implementations, the application servers 112 extract information (e.g., patient information, health care product information, accounting information, medical history information) from and/or transmit information to the client devices (110a, 110b, 110c) of the health care provider(s) 110. Extracting information can include copying at least some of the data contained on the client devices.

A given application server 112 includes one or more data processing apparatuses. The application servers 112 can communicate with each other and with storage systems (e.g., client data storage system 114 or health care product program storage system 116) at various times using one or more computer networks and/or communication devices. For example, the application servers 112 in the data center 130 can communicate through shared memory, network communication, or other means of inter or intra-process communication. A storage system can include, for example, a database server on which data and other information is stored.

The one or more application servers 112 also can communicate through the network 108 with one or more client devices (120a, 120b) operated by the health care product suppliers 120. The one or more client devices (120a, 120b) can receive health care product requests 102 from the application servers 112 and, in response to receiving requests 102, provide information regarding health care products including, for example, acceptance or denial of the application for a requested health care product. Additionally, in some implementations, the client devices (120a, 120b) can provide health care product tracking information for health care products delivered to the health care providers 110. Moreover, the client devices (120a, 120b) can store information 103 pertaining to patient eligibility requirements for receiving health care products at reduced or no cost.

In some implementations, the data center 130 also includes one or more client computing devices 150 coupled to the application servers 112. The client computing devices 150 can be operated by individuals for conducting operations such as reviewing requests sent to health care product suppliers, communicating with individuals associated with the health care providers and health care product suppliers.

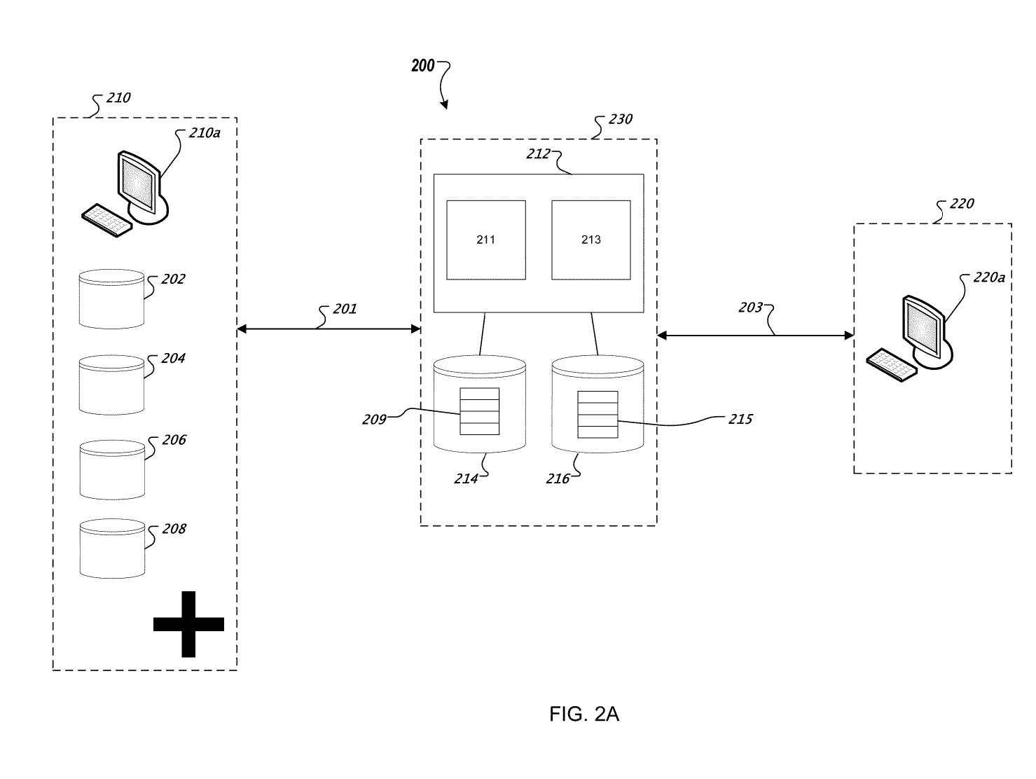

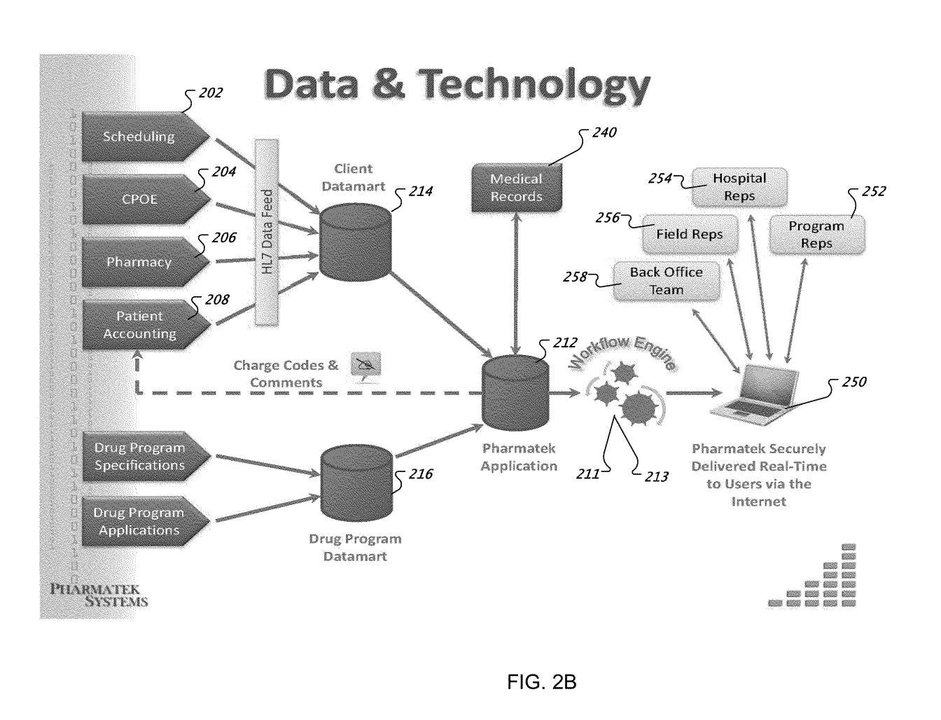

FIG. 2A is a schematic that illustrates an example of a connection between a health care provider 210 and a health care product request system 200 and between the health care product requests system 200 and a health care product supplier 220. As explained above with reference to FIG. 1, health care provider 210 can include one or more client devices 210a and one or more databases (e.g., 202, 204, 206, 208) that include information relating to patients and health care products. In the example of FIG. 2A, the health care provider 210 includes a scheduling database 202 for storing patient scheduling data, an order entry database 204 for storing health care product order data, a pharmacy database 206 for storing data regarding pharmaceutical products available to the health care provider and a patient accounting database 208 for storing patient accounting data, although other databases may be included as well. The databases can be stored on a single client device or multiple client devices.

The health care product request system 200 includes a client information database 214, a health care product program database 216, and one or more application servers 212 on which a patient assistance request engine 211 and a health care product program engine 213 run. The patient assistance request engine 211 is a computer program that runs on the application server 212. The patient assistance request engine 211 can be stored on the application server(s) 212 or on the client information database 214. In some implementations, the patient assistance request engine 211 is a separate computer program whereas in other implementations the patient assistance request engine 211 is combined with other computer programs that make up part of one or more applications (e.g., health care product program engine 213 or web applications) on the application server 212. In either case, the patient assistance request engine 211 is a rules based engine that can extract and/or receive information from the health care provider client devices 210a and store the information on the client information database 214. Based on a set of rules, the patient assistance request engine 211 can use the extracted and/or stored information to generate specialized request forms for participation in patient assistance programs and to send electronic notifications.

In an example, patient assistance request engine 211 accepts various data feeds 201, including hospital scheduling data, hospital patient accounting data and pharmacy/health care product data. In some implementations, the data can be extracted by the patient assistance request engine 211 from the hospital's databases (e.g., databases 202, 204, 206, or 208) and securely transmitted to the client information database 214 using any suitable data exchange protocol (e.g., health level seven (HL7) data exchange protocol). Data extracted using the HL7 protocol can be automatically uploaded to the patient assistance request engine 211 whenever the health care provider enters data into the one or more databases. In other implementations, the data is uploaded by a user (e.g., a doctor, nurse, or hospital administrator) to the patient assistance request engine 211 through a web interface displayed on a client device 210a. The web interface can be a graphical user interface generated by a web application executing on the application server 212. In some implementations, the user uploading the data is a patient advocate. A patient advocate visits a patient prior to or subsequent to receiving services from the health care provider to obtain, for example, basic patient information (e.g., name and address), confirm treatment appointments, explain the patient assistant program and documentation. In addition, the patient advocate may obtain other documentation relevant to whether a particular patient is eligible for a patient assistant program. A patient advocate may or may not work for the health care provider. Both the patient information obtained from the patient advocate and patient information extracted by patient assistance request engine 211 from the health care provider databases can be stored in the client information database 214.

The arrangement and labeling of data obtained from different health care providers can be client specific. That is, information obtained from a first health care provider may have data labels that are different from data labels used for similar information obtained from a second health care provider. For example, a first health care provider may store and label insurance policies with the policy account number and a title specific to the first health care provider whereas a second health care provider may use the policy account number, patient birth date, and a title specific to the second health care provider. In some implementations, the patient assistance request engine 211 normalizes the data from different health care providers prior to saving the data in the client information database 214. For example, the patient assistance request engine 211 can strip unnecessary information (e.g., client specific titles) from the data while preserving desired information (e.g., policy account number).

Examples of information that can be obtained from the health care provider client devices include: patient information such as patient name, birth date, home address, work address, phone number, and an alternate contact for the patient including the alternate contact's name, address and phone number; billing information such as tax identification number; insurance information such as insurance provider number (e.g., national plan identification (NPI) number) and doctor's current legacy provider number with medicare (e.g., provider transaction access number (PTAN)); prescription information such as prescription allowance identification numbers (e.g., drug enforcement agency (DEA) numbers); and patient medical information such as current and prior prescribed patient medications, current patient treatment program (e.g., therapy being applied to the patient, the line of therapy, the clinical stage, and/or whether the patient is outpatient or inpatient, previous treatments applied to the patient). Other information obtained from the health care provider 210 can include any signatures that might be required for submitting a health care product request to a health care supplier. For example, the signature can include a doctor's signature provided by a physician that has viewed and agreed to a completed health care product request application for a particular patient. In another example, the signature can include a patient signature provided by a patient or a patient's guardian that has viewed and agreed to terms of one or more forms that are part of a health care product request (e.g., medical information release form or a certification of income form). Signatures can be entered using the client device and stored electronically. For example, the signature can be entered by signing a digital copy of a request form, by inserting into a request form a saved version of a previously generated electronic signature, or by storing a scanned version of a print signature (e.g., on paper).

In some implementations, the data extracted from the health care provider client devices and databases can be filtered to obtain a list 209 of patients eligible for participation in a patient assistance program. The list 209 can include information such as each eligible patient's name, contact information, insurance information, treatment information (e.g., schedule, name(s) of health care product(s) prescribed to patient, dosage of health care product prescribed to patient), patient status information (e.g., whether the patient has been discharged or is currently still obtaining services from the health care provider), patient assistance program information (e.g., name of programs for which the patient is eligible or is participating in), as well as other patient information.

As explained above with reference to FIG. 1, health care product supplier 220 can include one or more client computing devices (e.g., 220a) to receive health care product requests 203 from the application servers 212 and, in response to receiving requests 203, provide information to the application servers 212, in which the information relates to health care products including, for example, acceptance or denial of the application for a requested health care product. Additionally, in some implementations, the client computing devices 220a can provide health care product tracking information for health care products delivered to the health care providers. Moreover, the client computing devices 220a can store information pertaining to eligibility requirements for receiving health care products at reduced or no cost.

Eligibility requirement information can be received and/or extracted by health care product program engine 213. The eligibility information can be different for each health care product supplier and may correspond to information contained in a health care product supplier specific application form available on the one or more client computing devices (e.g., 220a). Similar to the patient assistance request engine 211, the patient assistance program engine 213 is a computer program that runs on the application server 212. The health care product program engine 213 can be stored on the application server(s) 212 or on the health care product program database 216. In some implementations, the health care product program engine 213 is a separate computer program whereas in other implementations the health care product program engine 213 is combined with other computer programs that make up part of one or more applications (e.g., web applications) on the application server 212. In either case, the program engine 213 can store information on the health care product program database 216.

For example, the health care product program engine 213 can automatically obtain or receive, from a health care product supplier client computing device 220a program eligibility requirements such as, for example, patient insurance status, patient employment status, patient income level, patient age, and a list of health care products that can be obtained at a reduced cost or no cost through the product supplier patient assistance program. In some implementations, the health care product program engine 213 can automatically check the client computing device(s) 220a for updates to patient eligibility requirement. By “automatically,” it is meant that the health care product program engine 213 can perform operations without user prompting. In some implementations, the health care product program engine 213 can extract the patient eligibility requirements from patient assistance application documents stored on the client computing device(s) 220a using, for example, optical character recognition. Alternatively, or in addition, the program eligibility requirements can be entered manually using a computing device coupled to one or more servers of the system 212. The program eligibility requirements can be stored and categorized according to health care product supplier and/or health care product on a health care product program database 216.

In some implementations, the health care product program engine 213 can extract a list 215 of health care products that are available through a patient assistance program and store the list 215 of health care products in the health care program product database 216. The list 215 can be updated each time the health care product program engine 213 checks the client devices of the health care product suppliers. The checks can be automatically performed at regular intervals, such as every day, every week, or every month using the health. Alternatively, the check for updates to patient assistance programs offered by health care product supplier/manufacturers can be performed through inquiries to manufacturers and manual checks of manufacturer's websites.

In some implementations, the health care product program engine 213 can generate electronic application documents (e.g., Adobe portable document format) that include the program eligibility requirements as well as fields in which patients, doctors, or other users can enter in the required eligibility information. Separate application documents can be prepared for different health care products and/or for different health care product suppliers. The application documents can be stored on the health care program product database 216. When a patient or another user acting on behalf of the patient is applying to a patient assistant program, the patient assistance request engine 211 can access the health care program product database 216 to retrieve and display (e.g., through a graphical user interface of a client device 210a) an application document for the particular patient assistant program. In addition to patient eligibility requirements, the health care product program engine 213 can obtain and/or receive information related to health care product pricing and specifications from the supplier 230 where the information can also be store on health care product program database 216.

FIG. 2B is a schematic illustrating an example of data flow between a health care provider and a health care product request system and between the health care product requests system and a health care product supplier. As illustrated in FIG. 2B, copy of data from databases (e.g., scheduling database 202, pharmacy database 206, patient accounting data 208, and order entry database 204) of a health care provider is provided through an electronic communication network to patient assistance program database 214 through an HL7 data feed. In addition, copy of data (e.g., drug program patient eligibility requirements 222 and copies of drug program application forms 224) from databases of a health care product supplier is provided through the electronic communication network to health care program product database 216. Data from both the database 216 and database 214 then is obtained by one or more application servers 212 on which a patient assistance request engine 211 and a health care product program engine 213 run. The application servers 212 also may obtain from or provide to patient medical records 240 information related to the patient assistance program. The patient assistance request engine 211 and health care product program engine 213 are configured to compile the information into a health care product supplier specific document for requesting a health care product or reimbursement for a health care product's cost. Information from the patient assistance request engine 211 and health care product program engine 213 can be made available or sent to one or more client devices 250.

The client devices 250 can include client devices operated by users such as the health care product supplier, the health care provider or other individuals including, for example, program managers 258 that maintain and monitor the programs running on application servers 212. For example, in some implementations, information including, but not limited to, the health care product supplier specific document can be delivered electronically to a client device operated by the health care product supplier (e.g., through a supplier program representative 252). In some implementations, information including, but not limited to, status of reimbursement or product requests can be delivered electronically to a client device operated by representatives 254 of the health care provider. In some implementations, information including, but not limited to, patient data can delivered electronically to or received from a client device operated by a patient advocate 256. Once a health care provider is reimbursed or has obtained the health care product from the health care product supplier, the patient assistance request engine 211 is configured to update patient accounting records stored by the health care provider by using applicable charge codes and, in some cases, including comments regarding the changes to accounting information.

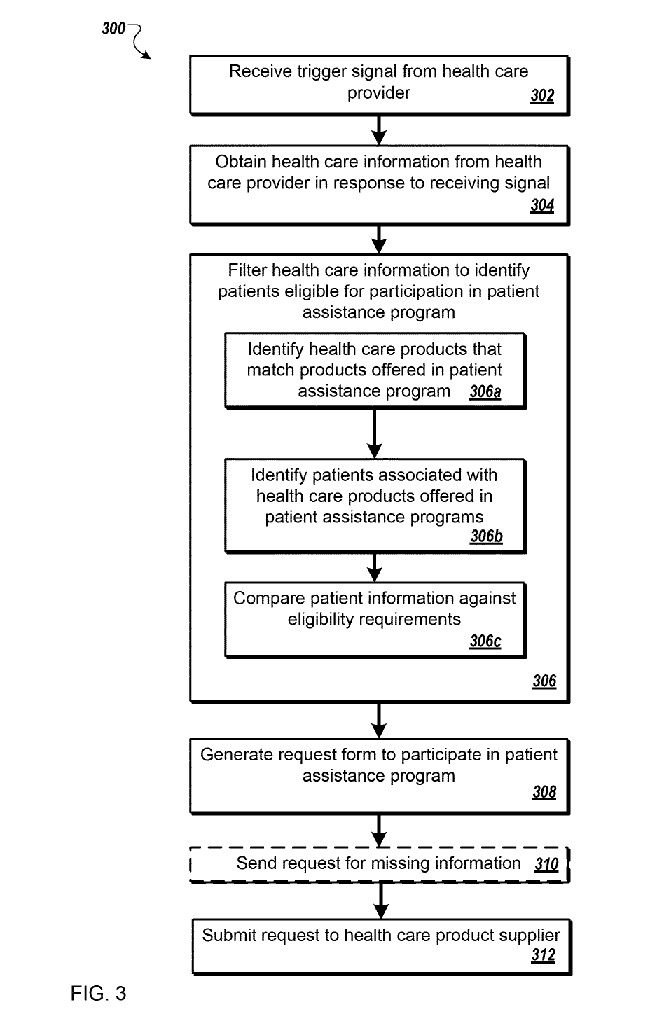

FIG. 3 is a flow chart of an example process 300 for participating in a patient assistant program, in which at least a portion of the process is implemented using one or more computer programs executing on one or more data processing apparatus such as the system 200 shown in FIG. 2A. In a first stage of the process 300, the system 200 receives (302) an electronic trigger signal that is generated as a result of the health care provider entering or modifying data in one or more of the health care provider databases. For example, when information relating to a patient is entered into a health care provider's system, an electronic trigger signal (e.g., a HL7 protocol compatible electronic signal) is generated by the client device 210 and sent to the patient assistance request engine 211. Signals can be generated from four primary databases associated with the health care provider and stored on the health care provider's system. The primary databases include a computerized physician order entry database, a provider scheduling database, a pharmacy information system database, and patient financial services database. The trigger signal identifies the identity of the health care provider for which patient information has been entered and can, in some implementations, also identify the type of data entry that was made (e.g., whether the data entry related to entering patient information, ordering a health care product, scheduling a patient treatment, or entering accounting information). For example, the trigger signal can be associated with a unique identifier that is specific to the health care provider. When the system 200 receives the trigger signal, the unique identifier is checked against a stored list of identifiers associated with health care providers to determine a match and thus determine from where the trigger signal was sent. Examples of data entry by the health care provider that can result in the issuance of a trigger signal include: entering or updating patient information (e.g., name, address, contact information) into the patient accounting database 206; entering or updating a treatment schedule for a patient into the scheduling database 202; placing an order for a drug or updating a previously existing drug order using the order entry database 204. Other types of data entry also can result in an electronic trigger signal being sent to the patient assistance request engine 211. Updating information in the one or more health care provider databases can include entering information in a database, modifying preexisting information in a database or deleting information from a database.

In response to receiving the electronic trigger signal, the patient assistance request engine 211 automatically extracts data (304) from the databases associated with health care provider from which the trigger signal was received. By “automatically,” it is meant that the operation is performed without the need for user intervention. Depending on the implementation, the extracted data can include a copy of the data stored on each database associated with the health care provider (e.g., scheduling database 202, an order entry database 204, a pharmacy database 206, a patient accounting database 208) or the extracted data can include a copy of the data related to the transaction which caused the trigger signal to issue. For example, the data could be extracted from the scheduling database 202 if the trigger signal was issued in response to a hospital administrator scheduling a treatment program for a particular patient. In some implementations, the extracted data is not limited to a particular patient or event and instead can include medical information relating to each patient who has received services, or will be receiving services at the health care provider. The extracted data also can include each of the different types of health care products (e.g., medication or medical devices) that have been or will be used at the health care provider, information relating to the quantity of health care products the provider currently has available, scheduling information for the different patients of the health care provider, and/or accounting information for each patient that has been serviced or will be serviced by the health care provider.

The extracted data can be stored in the client information database 214. In some implementations, the extracted data is normalized prior to saving the data in the database 214. As explained above with respect to FIG. 2A, stripping the extracted data can include removing from the data unnecessary information that is specific to the health care provider, such as health care provider specific titles and labels.

Optionally, the patient assistance request engine 211 can automatically extract the health care provider data without first receiving an electronic trigger signal. For example, in some implementations, the patient assistance request engine 211 can be configured to extract the data from the health care provider databases at regular intervals (e.g., every ten minutes, every thirty minutes, every hour, every six hours, or every twenty-four hours).

Following extraction, the patient assistance request engine 211 filters (306) the extracted data to identify patients eligible for participation in one or more patient assistant programs. Filtering the extracted data for eligible patients can include identifying (306a), from the extracted health care provider data, health care products that will be used or are being used by the health care provider and which match health care products being offered in a patient assistance program by one or more of the health care product suppliers. For example, the patient assistance request engine 211 can check each health care product in the data extracted from the health care provider against a list of health care products that are available in a patient assistance program (e.g., list 215). The list of medical products available from patient assistance program(s) can be stored in the health care product program database 216, which the patient assistance request engine 211 can access. The list can be created based on the program eligibility requirements that are obtained from health care product suppliers by the health care product program engine 213.

When a health care product that is being dispensed by the health care provider matches a product that is available as part of a patient assistance program, the patient assistance request engine 211 then identifies (306b) patients associated with the health care products that are being offered in a patient assistance program. For example, the engine 211 identifies patient who have been prescribed the health care products being offered in one or more patient assistance programs. The engine 211 stores information relating to those identified patients in a list 209 in database 214. The patient information can include, for example: the identity of a patient that used, will use or is currently using the health care product identified as being offered in a patient assistance program; patient accounting information, such as patient income, employment status, insurance status, insurance information; and patient scheduling information, such as planned treatment schedules for using the health care product and dosage, if applicable, for the health care product. The patient information also can be obtained from the extracted health care provider data. That is, the patient assistance request engine 211 can cross-check the extracted health care provider data against a product database to identify a potentially eligible patient and extract their patient information. For example, when a charity care patient is treated at a hospital using a particular drug, the charge transaction for the procedure is extracted and cross-checked by patient assistance request engine 211. If the particular drug used is contained in the list 215, the charity care patient can be identified as a potential candidate for receiving the drug free of charge or at a reduced cost. Further patient information, if necessary, can be extracted from the health care provider systems.

The patient information thus obtained is added to the list 209 so that the list 209 includes both the names of the health care products available through a patient assistance program as well as the names of any patients that may be using such health care products. The patient assistance request engine 211 subsequently identifies, from the list 209, the patients that are eligible to participate in the identified patient assistance programs. To determine if a patient is eligible, the patient assistance request engine 211 checks (306c) the patient information contained in the list 209 against the applicable eligibility requirements. For example, if a patient has been prescribed a cancer drug that is currently available through a patient assistance program, the patient assistance request engine checks the eligibility requirements of the patient assistance program for that cancer drug against the patient's information (e.g., income, insurance status, employment status). If the patient's information meets the eligibility requirements stipulated in the corresponding patient assistance program, the patient is identified by the patient assistance request engine 211 as eligible for participation in that program. Otherwise, the patient assistance request engine 211 identifies the patient as not eligible for that particular patient assistance program. For example, the patient assistance request engine 211 can update the list 209 to include an eligibility status of each patient in the list 209. In some implementations, a patient can be identified as being eligible for participating in more than one patient assistance program.

Subsequent to filtering the extracted health care provider data to identify eligible patients, the patient assistance request engine 211 generates (308) one or more request forms to participate in a patient assistance program. The request forms can be generated for each eligible patient in the list 209 and for each patient assistance program that the eligible patient can participate in. Before generating the form(s) for a patient, the engine 211 determines whether the patient is already participating in any patient assistance programs. If it is determined that a patient is currently participating in one or more programs, the engine 211 does not generate a request form for those programs. A request form can include a request for a particular health care product to be shipped to the health care provider or a request to reimburse the health care provider for the cost of a health care product used or prescribed.

To generate a request form, the patient assistance request engine 211 consolidates the required information as data entry fields in an electronic document (e.g., Adobe portable document format). The data entry fields that are incorporated into the document depend on the requirements of the patient assistance program for which the document is generated. That is, the request forms generated by the patient assistance request engine 211 correspond to application forms specific to the product supplier from which the health care product is being supplied or from which the health care provider is being reimbursed. Each product supplier may have a different form requiring different patient and/or other information. The patient assistance request engine 211 then obtains from The data entry fields of the request forms thus generated are auto-populated by the patient assistance request engine 211 with the corresponding applicable data. For example, in some implementations, a first patient assistance program requires the patient contact information, patient insurance information, employment status, and treatment schedule. A request form generated for a particular patient would then include data entry fields for each of those identified types of information. In contrast, a second different patient assistance program may require only the patient contact, insurance and employment information. Data entry fields for receiving a patient's treatment schedule would therefore be absent from a request form generated for the second patient assistance program. Using patient data available from the client information database 214, the patient assistance request engine 211 then auto-populates the data entry fields of the electronic document.

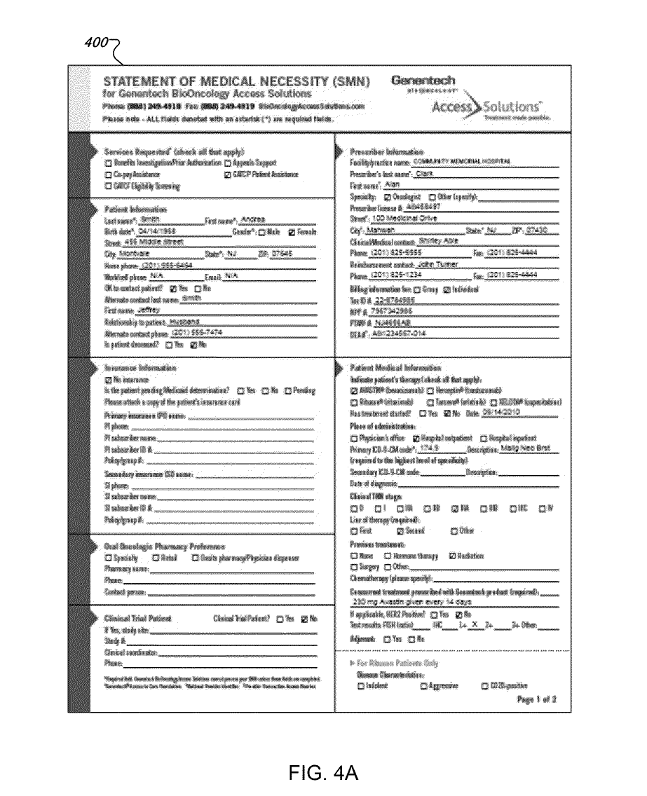

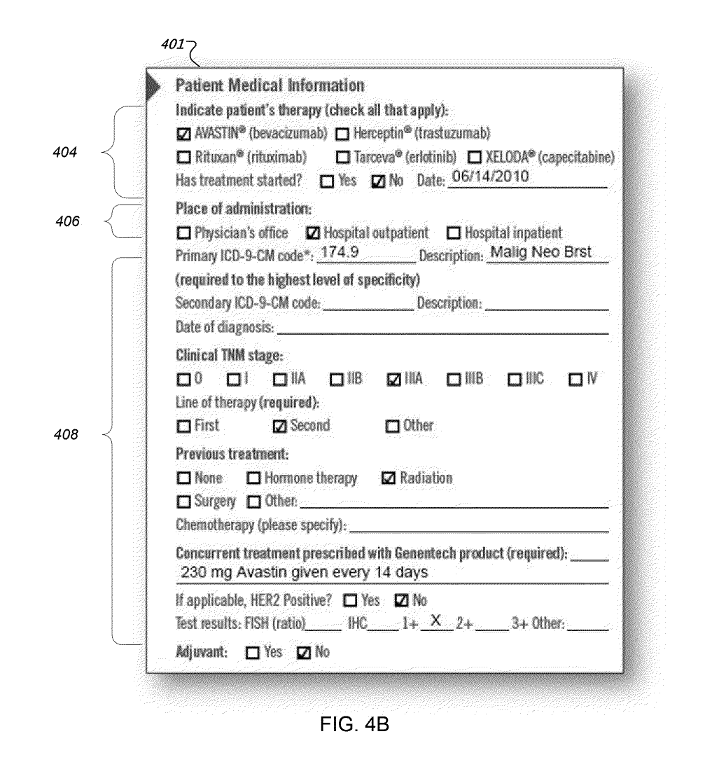

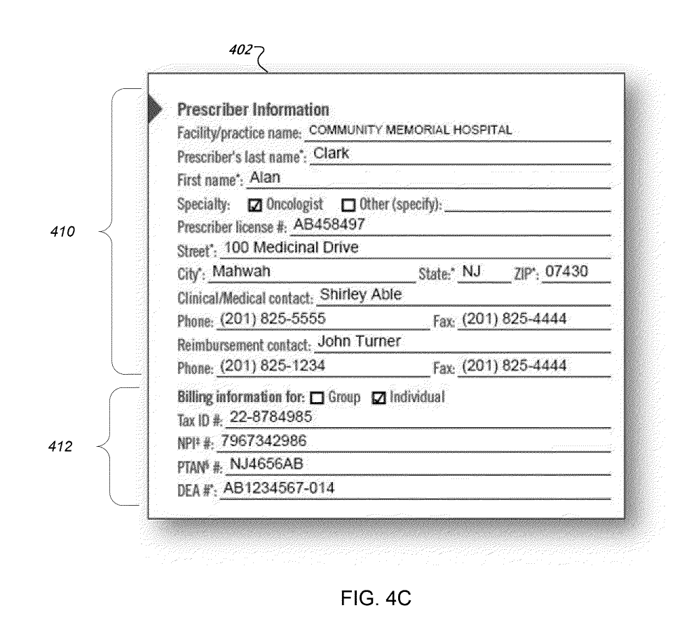

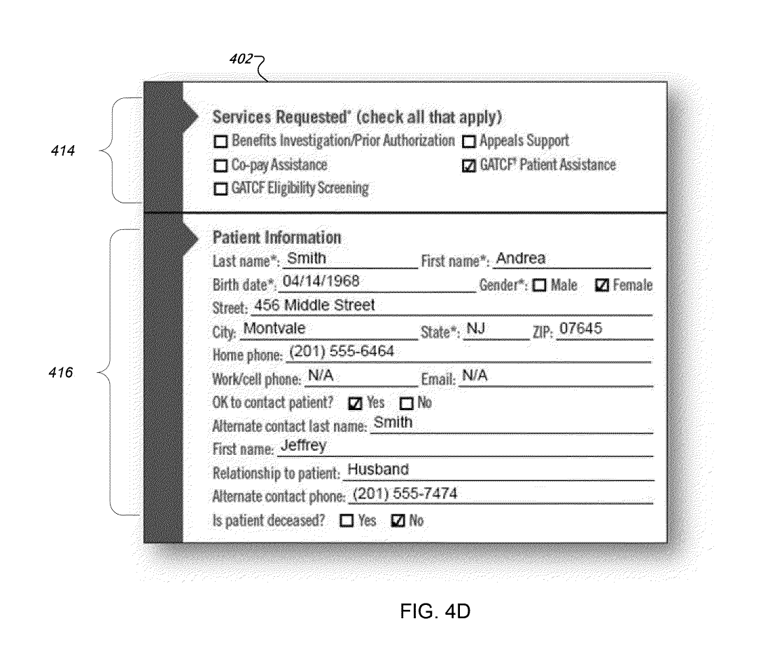

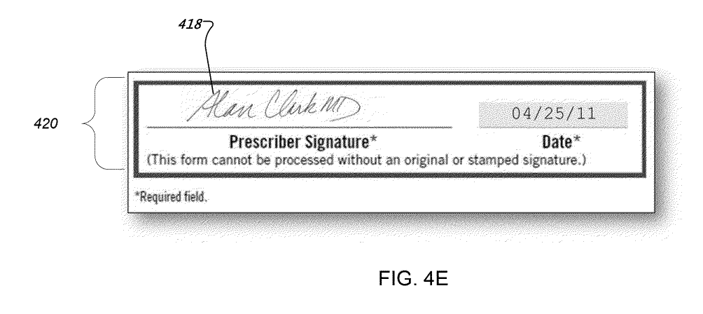

FIG. 4A is an example image of a document 400 generated by the patient assistance request engine 211. FIG. 4B is an example image of a first portion 401 of document 400 generated by the patient assistance request engine 211. The document 400 includes multiple data entry fields such as: fields 404 for identifying the health care product to be applied and the date treatment with the health care product will begin;

fields 406 for identifying the place at which administration of the health care will occur; and fields 408 for identifying other relevant medical information pertaining to the patient. FIG. 4C is an example image of a second portion 402 of document 400. As shown in FIG. 4C, the portion 402 includes: fields 410 for prescriber information, such as the health care provider identity, the prescribing physician, the health care provider address and contact information; and fields 412 for billing information. FIG. 4D is an example image of a third portion 403 of document 400. As shown in FIG. 4D, the portion 403 includes: fields 414 for identifying the service requested; and fields 416 for identifying the patient for which assistance is requested, such as the patient name and contact information. To the extent the data is available in the client information database 214, the data entry fields of the document are auto-populated.

If any data entry fields of the request form are still blank after auto-population, the patient assistance request engine 211 can optionally send (310) an inquiry to one or more individuals to provide the missing information (see FIG. 3). The inquiry can be sent using an electronic message such as an electronic text message or e-mail. For example, if a physician authorization signature is required before the request form can be submitted to the health care product supplier, the request engine 211 can send a notification message, such as a text message or e-mail, to a mobile phone number associated with the physician or to an e-mail address associated with the physician. In some implementations, the mobile phone number and/or e-mail address information can be stored in from the data extracted. The notification message can, in some implementations, include a hyperlink to a web page that allows the individual receiving the message to upload the missing information as a digital file. The web page can be hosted, for example, by a web server in system 200. In some implementations, the individual to whom the notification is addressed can respond with a reply message or e-mail including a copy of the missing information attached. For example, a physician sends a scanned copy of his/her signature as an attachment to an e-mail sent in reply to the notification. The reply e-mail or text message is received by the patient assistance request engine 211. In another example, the request for missing information can be sent to a health care provider administrative person requesting the missing information. Alternatively, or in addition, the request can be sent to a patient advocate with instructions to obtain missing information from the patient identified on the form. FIG. 4E is an example image of a signature 418 provided by a physician in a signature block 420 of request form 400.

Referring again to FIG. 3, once the patient assistance request engine 211 determines that the required fields of the request form are populated, the engine 211 submits (312) the request form to the health care product supplier 220 for which the form has been generated. For example, the request form can be sent to the health care product supplier electronically using e-mail. Alternatively, the request form can be printed out and submitted by mail or facsimile to the health care product supplier. In some implementations, the request form may be visually examined for quality assurance by one or more persons prior to submission to the health care product supplier. For example, the request form can be checked to determine whether all data entry fields have been populated with correct information or to determine whether the request is a duplicate of a previously submitted request.

Subsequent to populating the applicable entry fields of the request form or after a request form has been submitted to the health care product supplier, a copy of the form can be stored on health care product program database 216. The form on database 216 can be restricted from further editing or modifications for future auditing and tracking purposes. Accordingly, errors in the request form may necessitate generating a new instance of the form.

Upon receipt of the request form, the health care product supplier 220 evaluates the information contained in the form to make a determination as to whether the application for the health care product is granted or denied. In instances where the health care product supplier 220 has approved the request and will ship the health care product, the system 200 can operate to track the shipment until it reaches a final destination, such as a hospital, physician's office, or pharmacy. The system 200 optionally tracks the shipment through tracking information entered and stored in database 216. Tracking information can include, for example, a tracking number associated with a shipping provider, the expected time of arrival of the product to its final destination and the initial shipping date of the health care product. Tracking information about the shipment can be obtained directly by means of a phone call from an individual to the health care product supplier 220 or through a website, if the supplier 220 offers tracking information in that manner.

Based on the tracking information, the system 200, through a computer program operating on the applications server 212, can send out electronic notifications regarding the status of an order. For example, the system 200 can send out an e-mail to an address associated with a hospital administrator notifying the administrator of the expected date on which the health care product will arrive and/or its current shipping status. Such notifications can be generated automatically by the system 200 at regular intervals after a health care product has been shipped and terminated when the health care product arrives at its final destination. The system 200 can determine that a product has arrived at its final destination through the tracking information or through a delivery confirmation receipt. Delivery confirmation receipts can be sent to the system 200 electronically from the health care provider client device (or a client device of an entity associated with the health care provider, such as a pharmacy). For example, in some implementations, the system 200 will send an e-mail directed to a pharmacist asking the pharmacist whether the product has been received. The pharmacist can confirm delivery of the health care product by replying to the e-mail or by selecting a link embedded in the e-mail message, where the link connects to a website hosted by system 200 that allows the pharmacist to confirm delivery.

In some implementations, the request to participate in a patient assistance program is denied by the health care product supplier 220. The health care provider may, however, maintain the option to appeal the denial of the request. To aid the appeal process, the system 200 also can store electronic versions of draft appeal letters. The patient assistance request engine 211 can automatically populate appeal letters with specific information pertaining to the application request that was denied. For example, the letter can be auto-populated to include the patient name, the name of the supplier that denied the request and any applicable order numbers associated with the request. In another example, the letter can be auto-populated to include patient specific information relevant to the reason for denial, such as missing or incorrect patient information in the original request. Such automatic population can occur in response to a user initiated action, such as selection of interactive , Once populated, the letter can be supplied electronically by the system 200 to health care provider 210 for review and signature. The health care provider 210 can approve the letter and optionally send the letter back to the system 200 for submitting to a health care product supplier 220 (e.g., by e-mail or facsimile) or can send the letter directly to the supplier 220. In some implementations, the letter provide to the health care provider 210 can be customized by the health care provider before it is returned to the system 200.

In some implementations, the patient assistance program is promoted/sponsored by a health care product supplier that provides reimbursements for products, but not the actual health care product. Alternatively, or in addition, the health care provider has an existing stock of the health care product such that it is not necessary for the health care provider to obtain more of the health care product when participating in the patient assistance program. In other cases, the health care product may have already been used (e.g., the patient already received medication) and there is no need for the health care provider to obtain more. In such instances, the request form generated by the patient assistance request engine 211 can indicate that the health care provider is seeking reimbursement, as opposed to shipment of the health care product. Alternatively, the request form generated by the engine 211 can include a data entry field in which the health care provider would indicate that reimbursement or a new health care product is desired.

The patient assistance request engine 211 can determine whether to include a request for reimbursement based on the information stored in client information database 214. For example, in some cases, the client information database 214 stores pharmacy inventory information for a pharmacy associated with the health care provider. When the inventory of the desired health care product is empty or below a specified amount, the patient assistance request engine 211 can automatically include in the request form a request for the specified health care product instead of a reimbursement. In such cases, the patient assistance request engine 211 also can automatically enter pricing information for the reimbursement. For example, the engine 211 can recover the cost associated with the desired health care product from the client information database 214 and include the cost as the reimbursement amount in the request form.

In some implementations, the system 200 also can automatically determine when a health care product needs to be reordered and prepare a reorder request. For example, for each application to a patient assistance program that is approved, the patient assistance request engine 211 can extract from the patient treatment schedule stored in client information database 214 the date on which the prescribed health care product is set to be depleted. The patient assistance request engine 211 then schedules a reminder date for a point in time before the depletion date. When the reminder date is reached, the request engine 211 automatically generates a reorder request form and auto-populates the reorder request form with any applicable information necessary for obtaining a refill of the health care product, where the applicable information is retrieved from client information database 214. In some cases, the patient and/or physician may need to sign the reorder request form. Alternatively, or in addition, the patient assistance request engine 211 may require information that is missing from the reorder form in order to complete the form. In such instances, a patient advocate may obtain and upload the required signatures/missing information to the system 200. Alternatively, or in addition, the patient assistance request engine 211 can send electronic notifications (e.g., e-mail or text message) for the individuals whose signature is required and/or the individuals who can provide the missing information. As explained above, an individual can respond by uploading the requested information to the system 200 through, for example, a website, or can use a client device to send an electronic reply message that includes a copy of the missing information.

In some implementations, the system 200 can create management reports and make the reports available to the health care provider 210. The management reports can include detailed information regarding the status of applications that have been submitted to patient assistance programs as well as the benefits to the health care provider. For example, the system can generate reports that include information about the number and type of requests made to patient assistance programs including the number of requests that have been approved and the number of requests that have been denied. The management reports can include additional information such as, for example, reasons for denial of request, shipping information (e.g., when a product has shipped/will ship, arrival date, current shipping status), the number and type of health care products received to date through patient assistance programs, and the cost benefit of health care products obtained or reimbursed through patient assistance programs. In some implementations, the cost benefit can be broken down in the management reports based on various factors including, for example, the cost per type of health care product, the cost per patient, or the cost per time period (e.g., weeks, months, years). The management reports can be presented in different formats, such as graphs, tables or spreadsheets, depending on user selection. The system 200 can generate the reports in electronic format for presentation on a graphical user interface and can be accessed through a website hosted by the application servers of system 200. Alternatively, or in addition, the management reports can be sent as data files to client devices associated with the health care provider 210. In some implementations, the management reports can include interactive fields that allow a user to select which variables are to be presented in the reports.

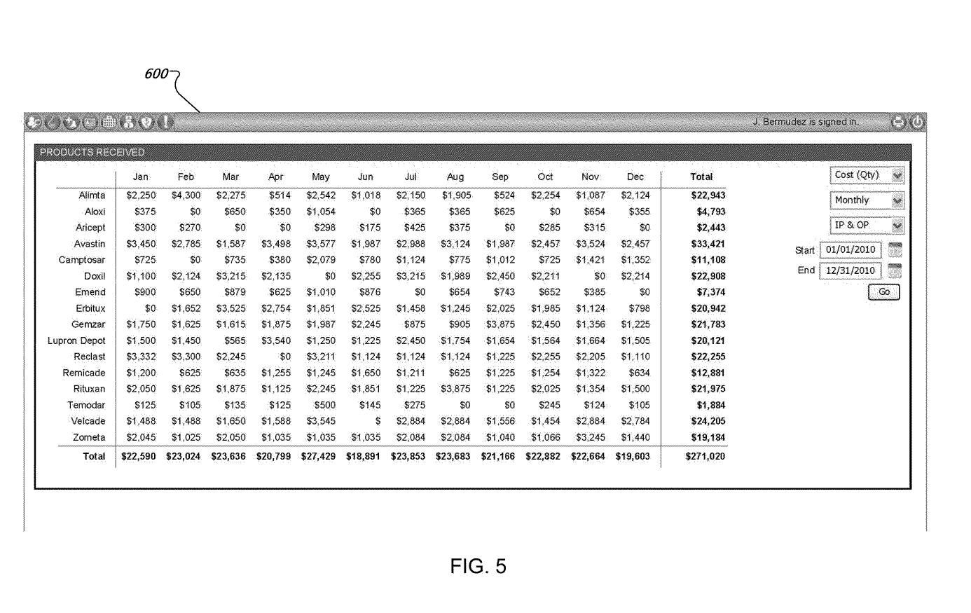

FIG. 5 is an example screenshot of a management report 500 produced by system 200 for presentation to a user in which the report includes a table of different health care products received by participating in patient assistance programs and the corresponding monthly cost benefit obtained for the health care provider.

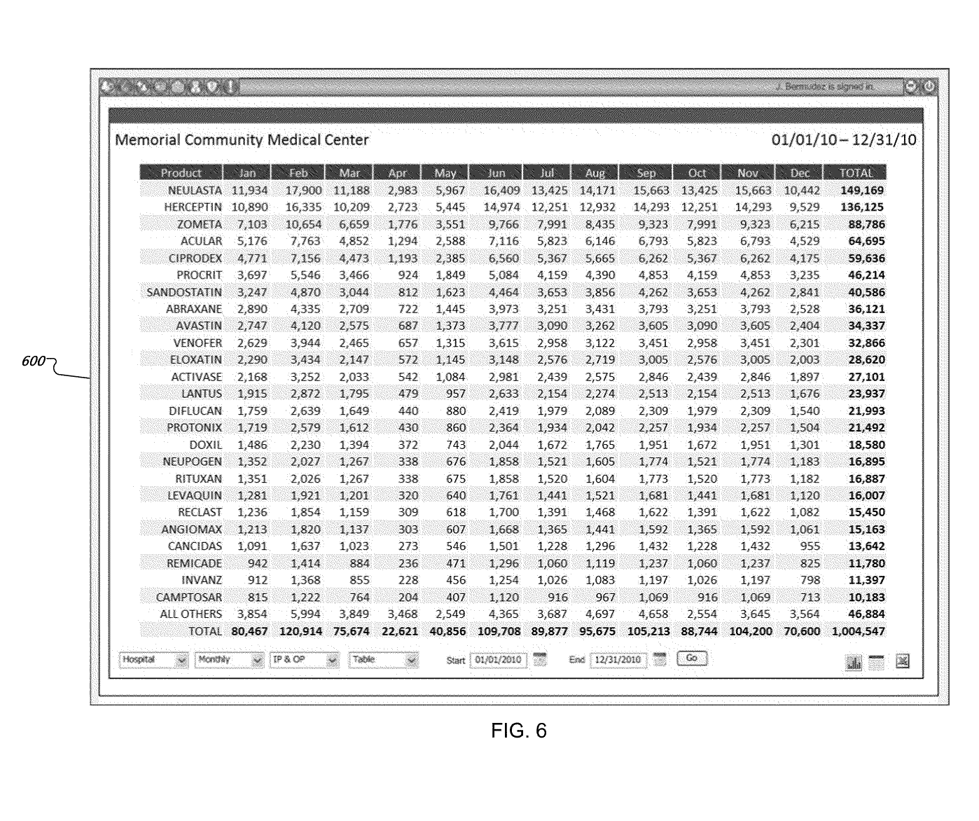

FIG. 6 is an example screenshot of a management report 600 produced by system 200 for presentation to a user in which the report includes a table of different health care products received in patient assistance programs and the corresponding amount of the health care products used each month, as well as the corresponding cost of health care products used and recovered through a patient assistance program.

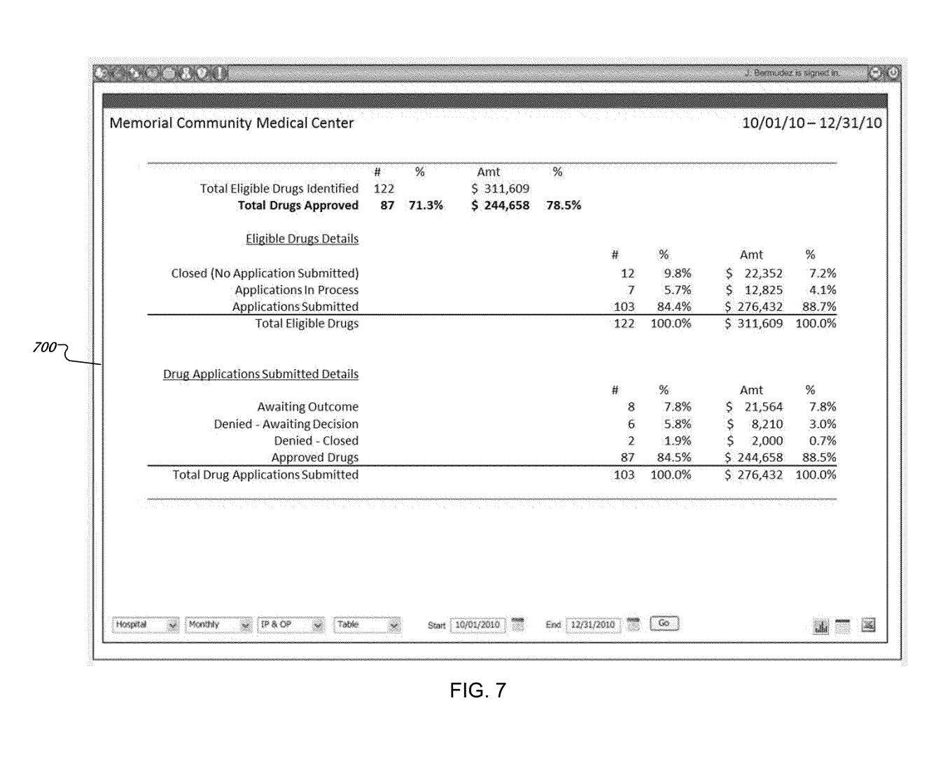

FIG. 7 is an example screenshot of a management report 700 produced by system 200 that includes a list of patients participating in patient assistance programs, the corresponding drug that has been prescribed to each patient, prescription information (such as dosage), and shipping information for the drug (such as the shipping provider, the date of shipment, estimated delivery and whether the drug has been received).

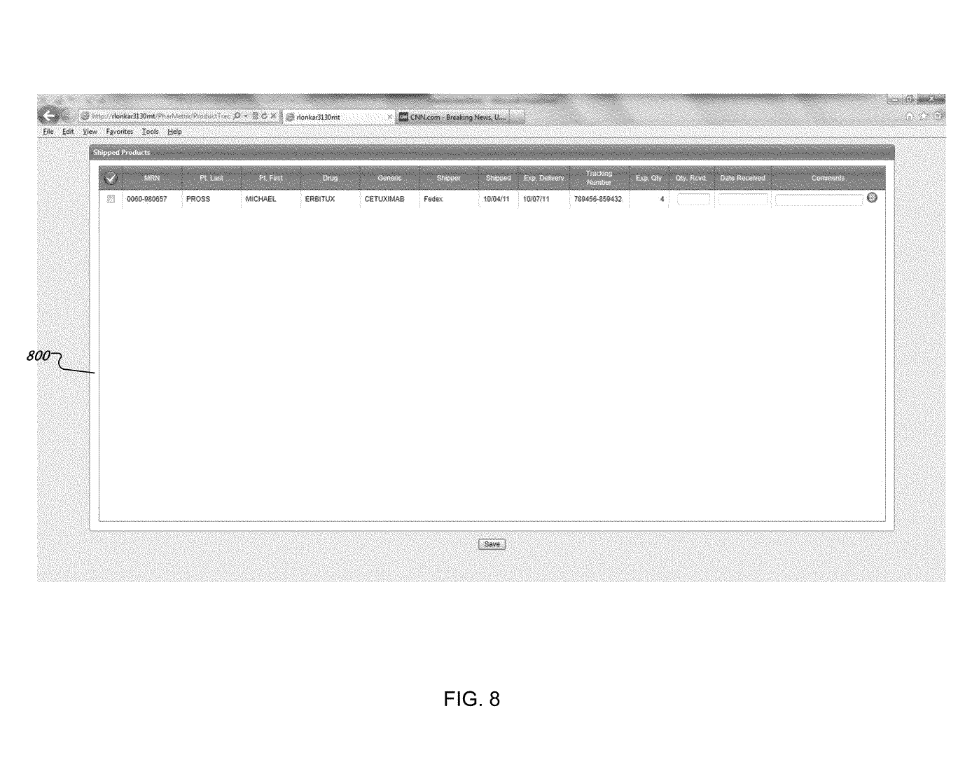

FIG. 8 is an example screenshot of a management report 800 produced by system 200 for tracking health care products. The report 800 includes an interactive list of products that have been approved and shipped, but not received yet. Upon receipt, a user, who may work for on the behalf of the health care provider, updates the information and the report is refreshed accordingly.

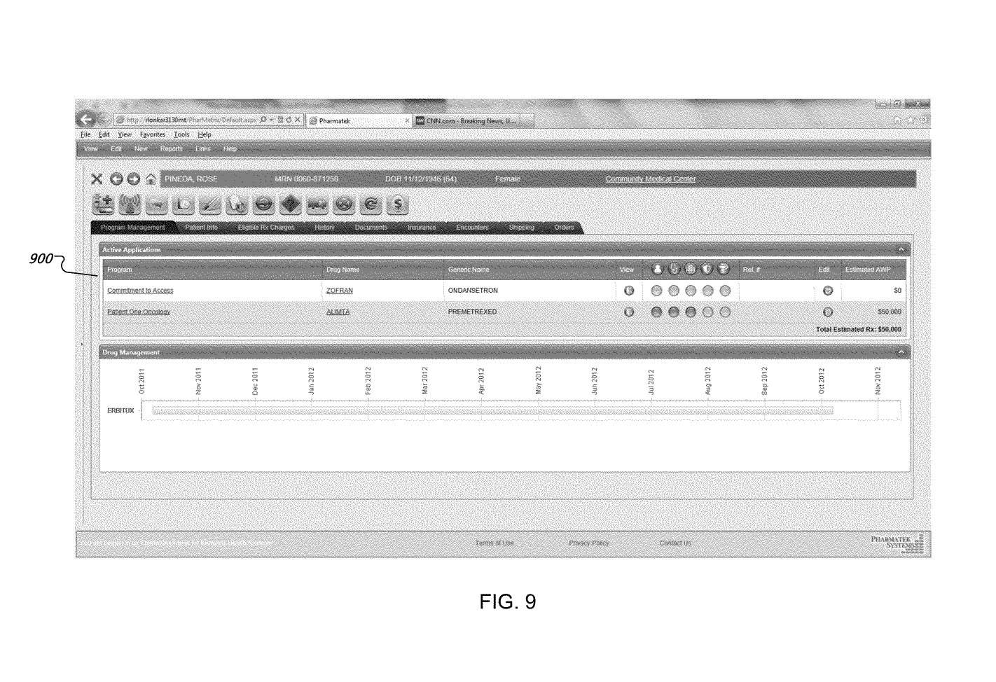

FIG. 9 is an example screenshot of a management report 900 produced by system 200 for managing patient information. The report 900 displays pertinent patient information which is used for research and generating the specific drug application(s). The interface also displays the status of applications and the approved product details.

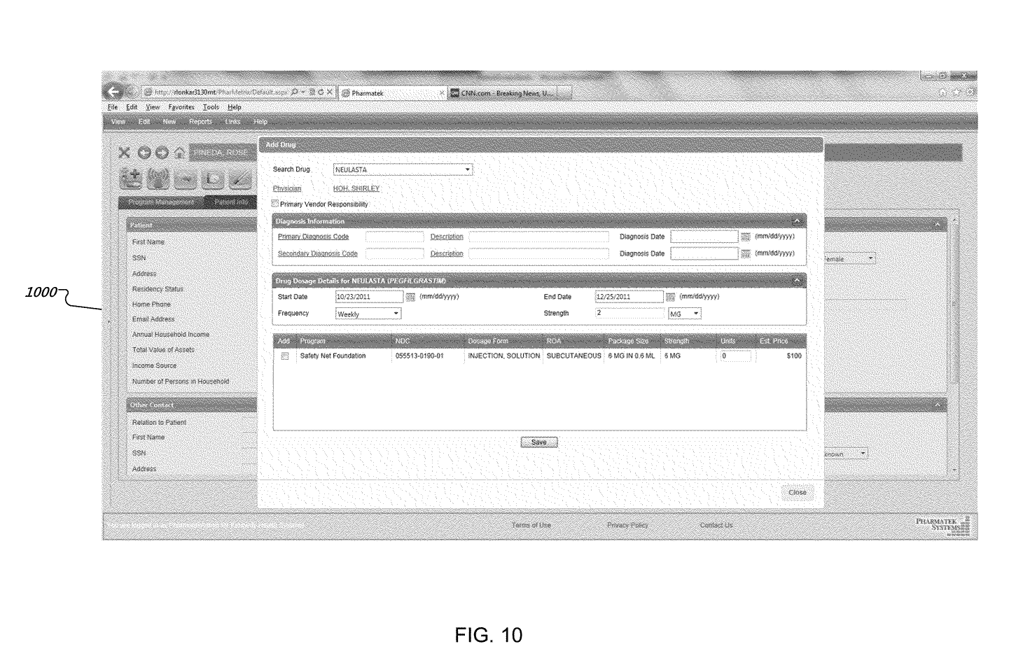

FIG. 10 is an example screenshot of a management report 1100 produced by system 200 that allows a user to add health care product information to health care products already associated with a patient. For example, a user can use the interactive management report 100 to
add additional prescription detail that may not have been captured yet, such as start date for use of the health care product, end date for using the health care product, frequency in which the product is to be used and strength of the health care product.

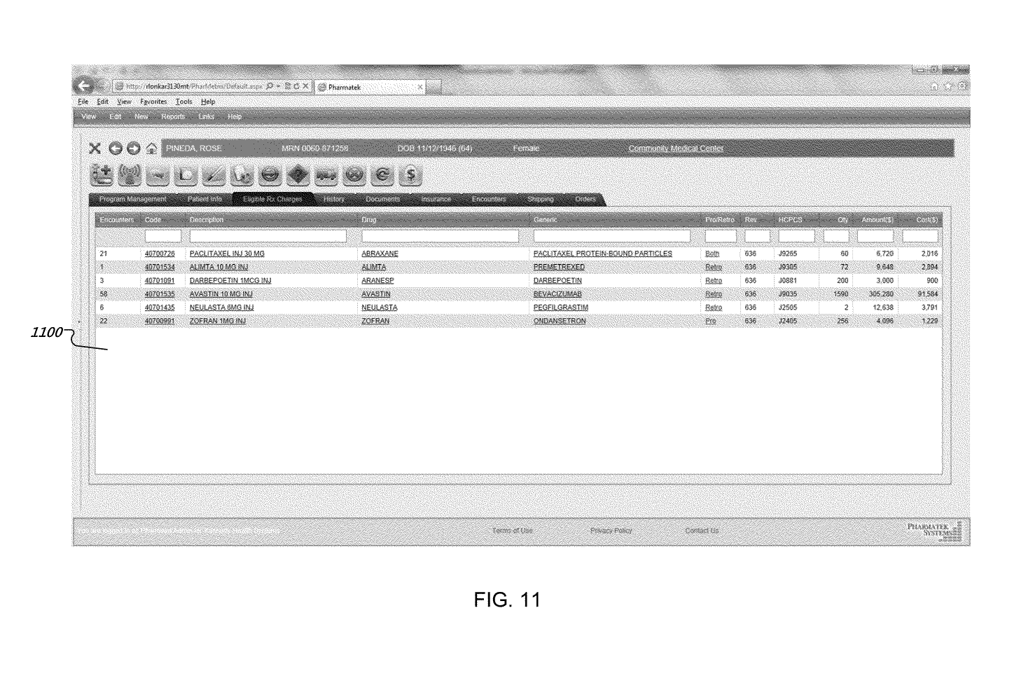

FIG. 11 is an example screenshot of a management report 1100 produced by system 200 for displaying information related to drugs eligible for participation in patient assistance programs. For example, the interactive management report 1100 provides health care product information such as date of health care product administered or quantity of the health care product administered.

In some implementations, the system 200 can automatically update health care provider accounting information based on reimbursements or based on health care products received at a reduced or no cost through a patient assistance program. For example, upon receipt of a health care product or monetary reimbursement by health care provider 210, the health care product request system 200 receives a trigger signal that includes information about the transaction. In response, system 200 transmits to heath care provider 210 accounting transaction instructions unique to the health care provider, in which the accounting transaction instructions include, for example, instructions for the health care provider system to debit an accounting record of the patient intended to receive the health care product, thereby reducing the patient's hospital bill. When the accounting transaction instructions are received by the health care provider 210, the provider system 210 updates the patient accounting record contained database 208. The purpose of this process is to comply with proper billing protocols and avoid “double-dipping”. Thus, a health care provider cannot bill a third party payer for any product or service that was replaced free of charge

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the invention.

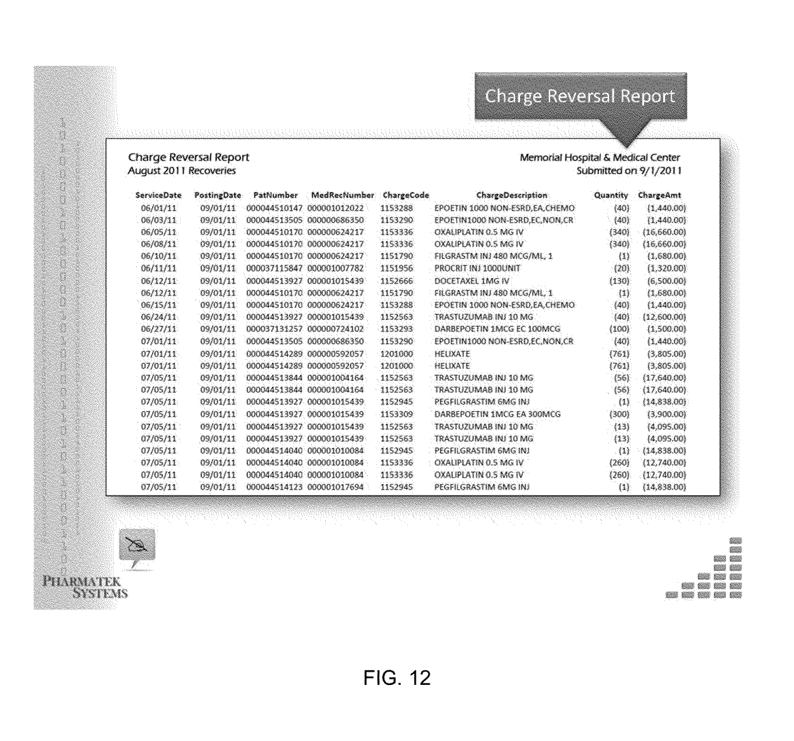

For example, referring to FIG. 2A, the system 200 can, in some implementations, update the patient accounting databases 208 to include what are typically referred to as “reversal” charges. Reversal charges occur when the health care provider 210 has previously charged a patient for the health care product and then received a reimbursement for the product or had the product successfully replaced through a patient assistance program. To preclude the health care provider 210 from receiving payment for a product that the provider 210 obtained for free, the system 200 automatically sends, through a communication network, an electronic “reversal” charge instruction to the patient accounting database 208 after the health care product has been replaced/reimbursed. The reversal charge instruction updates the patient accounting database to reverse the charge transaction to the patient. The health care provider 210 then is responsible for rebilling or submitting a corrected claim to the previously billed party (e.g., a patient). FIG. 12 is an example screenshot of a report 1200 produced by system 200 for tracking reversal charges. The report 1200 includes a list of charges that have been reversed as well as information such as, for example, the date on which the health care product was provided and initially charged to the patient (e.g., ServiceDate), the date on which the reversal charge was posted (e.g., PostingDate), a patient number associated with the patient for which the reversal charge is applied, a medical receipt number associated with the patient for which the reversal charge is applied (e.g., MedRecNumber), a charge code associated with the reversal charge (e.g., ChargeCode), a description of the health care product for which the charge is being reversed (e.g., ChargeDescription), the amount of the health care product dispensed (e.g., Qty.), and the total charge reversal amount (e.g., ChargeAmt). Other embodiments are within the scope of the following claims.

What is claimed is:

1. A computer-implemented method comprising:
receiving, from a health care provider client device, an electronic trigger signal, the trigger signal indicating a change in health care information stored in one or more electronic databases associated with the health care provider;
obtaining, from the one or more electronic databases and in response to receiving the trigger signal, health care provider information;
filtering, using one or more computer-processors, the health care provider information to identify a patient eligible for participation in a patient assistant program;
generating a health care product request application for a patient identified as eligible for participation in the patient assistant program; and
outputting the health care product request application.

2. The computer-implemented method of claim 1, wherein filtering comprises identifying, from the health care provider information, a health care product being offered in the patient assistance program.

3. The computer-implemented method of claim 2, wherein filtering further comprises identifying a patient associated with the health care product being offered in the patient assistance program.

4. The computer-implemented method of claim 3, wherein filtering further comprises comparing patient information associated with the patient against the eligibility requirements of the patient assistance program and identifying the patient as an eligible patient when the patient information meets the eligibility requirements.

5. The computer-implemented method of claim 4, wherein generating the health care product request application comprises populating the health care product request application with at least some of the patient information.

6. The computer-implemented method of claim 4, wherein the patient treatment information comprises patient medication information.

7. The computer-implemented method of claim 4, wherein the patient treatment information comprises a treatment schedule for the patient.

8. The computer-implemented method of claim 4, wherein the patient treatment information comprises patient accounting information.

9. The computer-implemented method of claim 1, wherein outputting the health care product request application comprises submitting the treatment product application to a health care product supplier.

10. The computer-implemented method of claim 1, wherein the health care product request application includes a request for reimbursement of the cost of a health care product.

11. The computer-implemented method of claim 1, wherein the health care product request application includes a request for a health care product.

12. The computer-implemented method of claim 11, wherein the health care product request application is a request for a refill of the health care product.

13. A system comprising:
one or more computing devices configured to perform operations including:
receiving, from a health care provider client device, an electronic trigger signal, the trigger signal indicating a change in health care information stored in one or more electronic databases associated with the health care provider;
obtaining, from the one or more electronic databases and in response to receiving the trigger signal, health care provider information;
filtering, using one or more computer-processors, the health care provider information to identify a patient eligible for participation in a patient assistant program;
generating a health care product request application for a patient identified as eligible for participation in the patient assistant program; and
outputting the health care product request application.

14. The system of claim 13, wherein filtering comprises identifying, from the health care provider information, a health care product being offered in the patient assistance program.

15. The system of claim 14, wherein filtering further comprises identifying a patient associated with the health care product being offered in the patient assistance program.

16. The system of claim 15, wherein filtering further comprises comparing patient information associated with the patient against the eligibility requirements of the patient assistance program and identifying the patient as an eligible patient when the patient information meets the eligibility requirements.

17. The system of claim 16, wherein generating the health care product request application comprises populating the health care product request application with at least some of the patient information.

18. The system of claim 16, wherein the patient treatment information comprises patient medication information.

19. The system of claim 16, wherein the patient treatment information comprises a treatment schedule for the patient.

20. The system of claim 4, wherein the patient treatment information comprises patient accounting information.

21. The system of claim 13, wherein outputting the health care product request application comprises submitting the treatment product application to a health care product supplier.

22. The system of claim 13, wherein the health care product request application includes a request for reimbursement of the cost of a health care product.

23. The system of claim 13, wherein the health care product request application includes a request for a health care product.

24. The system of claim 23, wherein the health care product request application is a request for a refill of the health care product.

25. A storage medium having instructions stored thereon that, when executed by data processing apparatus, cause the data processing apparatus to perform operations comprising:
receiving, from a health care provider client device, an electronic trigger signal, the trigger signal indicating a change in health care information stored in one or more electronic databases associated with the health care provider;
obtaining, from the one or more electronic databases and in response to receiving the trigger signal, health care provider information;
filtering, using one or more computer-processors, the health care provider information to identify a patient eligible for participation in a patient assistant program;
generating a health care product request application for a patient identified as eligible for participation in the patient assistant program; and
outputting the health care product request application.

26. The storage medium of claim 25, wherein filtering comprises identifying, from the health care provider information, a health care product being offered in the patient assistance program.

27. The storage medium of claim 26, wherein filtering further comprises identifying a patient associated with the health care product being offered in the patient assistance program.

28. The storage medium of claim 27, wherein filtering further comprises comparing patient information associated with the patient against the eligibility requirements of the patient assistance program and identifying the patient as an eligible patient when the patient information meets the eligibility requirements.

29. The storage medium of claim 28, wherein generating the health care product request application comprises populating the health care product request application with at least some of the patient information.

30. The storage medium of claim 28, wherein the patient treatment information comprises patient medication information.

31. The storage medium of claim 28, wherein the patient treatment information comprises a treatment schedule for the patient.

32. The storage medium of claim 28, wherein the patient treatment information comprises patient accounting information.

33. The storage medium of claim 1, wherein outputting the health care product request application comprises submitting the treatment product application to a health care product supplier.

34. The storage medium of claim 1, wherein the health care product request application includes a request for reimbursement of the cost of a health care product.

35. The storage medium of claim 1, wherein the health care product request application includes a request for a health care product.

36. The storage medium of claim 35, wherein the health care product request application is a request for a refill of the health care product.
